(19) United States
(12) Patent Application Publication
(10) Pub. No.: US 2020/0180374 A1
(43) Pub. Date: Jun. 11, 2020

(54) Coupling Unit

(71) Applicants: Wolfgang Gentner, Steinheim (DE); Alexander Kaufmann, Brackenheim (DE); Michael Widmann, Leonberg (DE)

(72) Inventors: Wolfgang Gentner, Steinheim (DE); Alexander Kaufmann, Brackenheim (DE); Michael Widmann, Leonberg (DE)

(21) Appl. No.: 16/709,496

(22) Filed: Dec. 10, 2019

(30) Foreign Application Priority Data
Dec. 11, 2018 (DE) 102018131737.9

(51) Int. Cl. B60D 1/54; B60D 1/06; B60D 1/62

(52) U.S. Cl. CPC B60D 1/54; B60D 1/62; B60D 1/06

(57) ABSTRACT

In order to improve a coupling unit that is mountable on the rear end of a vehicle body and comprises a carrier unit which, for its part, is mountable on the vehicle body hidden by a bumper unit and which comprises a coupling arm held on the carrier unit for coupling a trailer or a rear load carrier, in such a way that detection of the mechanical loads on the coupling unit is possible in a simple way, it is proposed that there be provided at least one force detecting region on sections of the coupling unit that are mechanically loaded by the coupled trailer or the coupled rear load carrier, in which a sensor associated with this force detecting region detects the mechanical load acting on this force detecting region by means of the magneto-elastic effect.

### CROSS-REFERENCE TO RELATED PATENT APPLICATION

This patent application claims the benefit of German application No. 10 2018 131 737.9, filed Dec. 11, 2018, the teachings and disclosure of which are hereby incorporated in their entirety by reference thereto.

### BACKGROUND OF THE INVENTION

The invention relates to a coupling unit that is mountable on the rear end of a vehicle body and comprises a carrier unit which, for its part, is mountable on the vehicle body hidden by a bumper unit and which comprises a coupling arm that is held on the carrier unit for coupling a trailer or a rear load carrier.

In the case of coupling units of this type, there exists the problem of detecting the mechanical loads both when the vehicle is stationary and when the vehicle is being driven.

Consequently, the object of the invention is to improve a coupling unit of the type described hereinabove in such a way that it is possible to detect the mechanical loads on the coupling unit in a simple manner.

### SUMMARY OF THE INVENTION

In accordance with the invention, this object is achieved in the case of a coupling unit of the type described hereinabove in that at least one force detecting region is provided on sections of the coupling unit that are mechanically loaded by the coupled trailer or the coupled rear load carrier, in which a sensor associated with this force detecting region detects the mechanical load acting on this force detecting region by means of the magneto-elastic effect.

The advantage of the solution in accordance with the invention is to be seen in that a sensor which detects mechanical loads by means of the magneto-elastic effect is mountable in a simple manner and works reliably and apart from this has the property of being able to detect mechanical loads with a high signal-to-noise ratio which do not have to entail significant deformations of the loaded section, for example, because the loaded section is dimensioned such that it is only insignificantly deformed by the loads occurring.

This is because the mechanical loads lead to an alteration of the magnetic permeability in the material of the force detecting region which a sensor in accordance with the invention can easily detect by means of the magneto-elastic effect.

One expedient solution for carrying out the process of detecting the mechanical load envisages that the at least one force detecting region comprise an effective surface by means of which the sensor couples a magnetic field into a detection layer of the force detecting region which carries the effective surface and is subjected to the mechanical load in order to detect the load that is acting in this detection layer by means of the magneto-elastic effect.

The load effective in the detection layer may be a tensile load and/or a compressive load and/or a torsional load.

The load can run approximately parallel to the effective surface.

There is also the possibility however of detecting loads which run transversely to the effective surface.

In regard to the arrangement of the force detecting region all that has been defined up to now in the context of the solution in accordance with the invention is that it should be arranged on a loaded section of the coupling unit.

One particularly expedient solution envisages that the at least one force detecting region be provided on the coupling arm.

In regard to the arrangement of the effective surface of the force detecting region the most diverse of solutions are likewise conceivable.

Thus one advantageous solution envisages that the effective surface associated with the force detecting region be located on an outer surface of the coupling arm.

In connection therewith, the outer surface of the coupling arm on which the effective surface is located can run approximately transversely to a vertical longitudinal centre plane of the coupling arm in a working position of the coupling arm.

As an alternative or in addition thereto, it is also possible for the outer surface in which the effective surface of the force detecting region lies to run approximately in a direction parallel to a vertical longitudinal centre plane in a working position of the coupling arm, wherein an approximately parallel path should still include deviations of ±30° and can otherwise also include a domed shaping of the outer surface.

As an alternative or in addition to the arrangement of the effective surface on an outer surface of the coupling arm, a further solution envisages that the effective surface associated with the force detecting region be located in a free space thereof that is formed by the coupling arm.

Hereby, a free space of the coupling space is to be understood as a space which is accessible through an opening in an outer contour of the coupling arm and penetrates into it.

Thus, one advantageous embodiment of the coupling arm envisages that the coupling arm comprise a carrying structure which is connected by a first end region to the carrier unit and which carries a coupling element in the form of a ball coupling for example at a second end region, wherein the carrying structure comprises a bracing structure which connects the first end region to the second end region and supports the second end region relative to the first end region and which, in the working position of the coupling arm, extends in particular on both sides of a geometrical central planar surface which itself extends in parallel with a central axis of the coupling element and which comprises longitudinal struts that each run from one end region to the other end region and between which there extends at least one connecting element that runs transversely relative to the longitudinal struts and wherein at least one free space extending transversely relative to the geometrical central planar surface lies between the longitudinal struts.

A construction of the carrying structure of this type has the advantage that it opens up the possibility of reducing the mass of the coupling element whilst still maintaining adequate stability.

In particular, it is advantageous thereby if a longitudinal strut facing the road surface in the working position of the coupling arm exhibits a greater linear expansion than a longitudinal strut that is remote from the road surface.

Furthermore, provision is expediently made for the longitudinal strut that faces the road surface to extend on both sides of the geometrical central planar surface.

It is particularly expedient if the longitudinal strut facing the road surface extends symmetrically relative to the geometrical central planar surface.

Furthermore, provision is preferably made for a longitudinal strut that is remote from the road surface to extend on both sides of the geometrical central planar surface in the working position.

It is also particularly expedient here, if the longitudinal strut that is remote from the road surface extends symmetrically relative to the geometrical central planar surface.

Furthermore, provision is preferably made for at least one free space extending in the bracing structure transverse to the central planar surface to be located on at least one side of a connecting element.

Furthermore, a particularly expedient solution envisages that the bracing structure comprise at least one free space which passes through the bracing structure as a whole in a direction transverse to the central planar surface.

As an alternative or in addition thereto, provision is made for the bracing structure to comprise at least one free space which extends transversely relative to the central planar surface, but which however is closed by a connecting wall of the bracing structure that extends between the longitudinal struts and forms a connecting element.

In the case of a construction of the coupling arm of this type, the force detecting region and the corresponding effective surface can be arranged at differing locations of the carrying structure.

Thus, one advantageous solution envisages that the force detecting region and the effective surface be arranged on one of the longitudinal struts.

The longitudinal struts are subjected primarily to tensile, thrust and bending forces when the coupling arm is loaded so that vertical loads and loads in the direction of travel and, if need be, loads transverse to the direction of travel as well can be detected advantageously at the longitudinal struts.

Another solution envisages that the force detecting region and the effective surface be arranged on a connecting element.

In a case of this type, vertical loads in particular and, if need be, loads in the direction of travel as well, and possibly too, loads transverse to the direction of travel can be detected.

It is particularly expedient, if the effective surface is arranged on an outer surface of the carrying structure, since in this case, the sensor associated with the effective surface can be mounted in a simple manner.

However, another advantageous solution envisages that the effective surface be arranged on a side of the carrying structure facing the free space.

A solution of this type has the great advantage that the sensor associated with the effective surface can then be arranged in the free space of the carrying structure.

Furthermore, in connection with the explanation of the individual exemplary embodiments that has been given up to now, no details have been revealed as to the position in the longitudinal direction of the coupling arm at which the force detecting region and the effective surface should be provided.

Thus, one particularly advantageous solution envisages that the force detecting region and the effective surface be arranged at the first end region of the coupling arm.

This solution has the advantage that the loads that are to be detected are very large in the first end region and hence can be easily detected.

Another advantageous solution envisages that the force detecting region and the effective surface be arranged between the first and the second end region.

These solutions have the advantage that in this case then, the sensors associated with the effective surface can be arranged in a spatially expedient manner and are easily accessible.

A further advantageous solution envisages that the at least one detection region be arranged on the carrier unit.

The carrier unit is also subject to the mechanical loads occurring with a coupled trailer or with a rear load carrier in place so that mechanical loads on the carrier unit can also be detected by a sensor by means of the magneto-elastic effect.

To this end for example, provision is made for at least one detection region to be provided on a cross-beam of the carrier unit.

A cross-beam of the carrier unit of this type, which extends transverse to the longitudinal centre plane, preferably experiences tensile and thrust loads as well as torsional loads which can be detected in a simple way at the cross-beam since the latter provides the opportunity for an adequate number of spatial positions for detecting the loads and arranging the effective surfaces due to its extent transverse to the longitudinal central plane.

In connection with the explanation of the solution in accordance with the invention that has been given up to now the provision of at least one force detecting region has been presumed.

However, it is particularly advantageous, if provision is made for a plurality of force detecting regions to be provided on one or more loaded sections or to be distributed over a plurality of loaded sections since the process of detecting the loads can be improved by using a plurality of sensors and a plurality of force detecting regions.

It is particularly expedient thereby, if the loads in different force detecting regions are detected by means of the magneto-elastic effect with an emphasis on differing directions of detection.

In connection therewith, for example, provision is made for the different detection regions to experience primarily loads in different directions of detection and thus the sensors associated with these detection regions can then also primarily detect the loads in these detection directions.

Moreover, preferred directions of detection for the loads can also be predefined by the arrangement and orientation of the sensors.

Thus in particular, the detection directions in which loads can be primarily detected by the magneto-elastic effect by means of the sensors can be specified by suitable selection of the detection regions in dependence on the loads primarily arising therein and supplemented by suitable arrangement and orientation of the sensors within these detection regions.

In regard to the construction of the sensors, no detailed information has so far been provided.

Thus, one advantageous solution envisages that each sensor should comprise magnetic poles having header surfaces that face the detection surfaces.

In particular thereby, the header surfaces are arranged at a spacing from the effective surface.

In this case, a defined arrangement of the header surfaces relative to the effective surface is necessary.

For this reason, provision is preferably made for a gap of non-magnetic material to be provided between the effective surface and the respective header surfaces.

The gap could be an air gap for example.

A particularly advantageous solution envisages that the gap be formed by a layer of non-magnetic material.

A particularly expedient solution envisages that the gap be formed by a layer of plastics material.

In regard to the mounting of the sensor, the most varied of solutions are conceivable in order to fix the sensor relative to the respective effective surface in a defined manner.

For example, it would be conceivable to connect the sensor to the effective surface by a jointed connection, for example by means of a jointed connection between the sensor and the layer of synthetic material as well as the layer of synthetic material and the effective surface.

One particularly advantageous solution envisages that the sensor be fixed relative to the respective effective surface by means of a holding device that acts on the sensor.

It is particularly expedient if the holding device subjects the sensor to a force in the direction of the effective surface so that the sensor is permanently subjected to a force in the direction of the effective surface.

For the purposes of detecting the magneto-elastic effect, provision is preferably made for the detection layer to be formed by a ferromagnetic material.

It is particularly expedient, if the detection layer comprises chromium steel.

In principle, it would be conceivable for the detection layer to be formed by a ferromagnetic layer which experiences the same loads as the force detecting region and which is applied to the force detecting region and connected thereto over a large surface area.

It is particularly expedient, if the detection layer is formed by the material of the force detecting region in the respective section of the coupling unit, thus in particular, by the material of the coupling arm or the material of the carrier unit itself.

Preferably in this connection, provision is made for the force detecting region to be a region of the coupling unit which experiences loads that amount to at least 50% of the maximum load on the coupling unit in order to obtain measured results that are as reliable as possible.

In regard to the sensor itself, no detailed information has been given in connection with the explanation given up to now of the solution in accordance with the invention.

Thus, in the case of a sensor for detecting the magneto-elastic effect, provision is made for it to comprise an excitation coil and at least one measuring coil, preferably, a plurality of measuring coils.

Furthermore, in the case of a sensor of this type, provision is made for the excitation coil to be controlled by an exciter control system which operates the excitation coil at one or more frequencies.

Furthermore, provision is preferably made for a signal evaluation unit to be arranged in the sensor for processing the signals received in the at least one measuring coil and for producing a signal which represents a measure for the loading on the force detecting region in the loaded state relative to the unloaded state.

The preceding description of solutions in accordance with the invention thus comprises in particular the various combinations of features that are defined by the following consecutively numbered embodiments:

1. Coupling unit (20) that is mountable on the rear end of a vehicle body (14) and comprises a carrier unit (42) which, for its part, is mountable on the vehicle body (12) hidden by a bumper unit (56) and which comprises a coupling arm (22) that is held by the carrier unit (42) for coupling the trailer or the rear load carrier, wherein at least one force detecting region (122) is provided on sections of the coupling unit (20) that are mechanically loaded by the coupled trailer or the coupled rear load-carrier in which a sensor (132) associated with this force detecting region (122) detects the mechanical load acting on this force detecting region (122) by means of the magneto-elastic effect.

2. A coupling unit according to embodiment 1, wherein the at least one force detecting region (122) comprises an effective surface (124) by means of which the sensor (132) couples a magnetic field into a detection layer (126) of the force detecting region (122) which carries the effective surface (124) and is subjected to the acting mechanical load in order to detect the load that is acting on this detection layer (126) by means of the magneto-elastic effect.

3. A coupling unit in accordance with any of the preceding embodiments, wherein the at least one force detecting region (122) is provided on the coupling arm (22).

4. A coupling unit according to embodiment 3, wherein the effective surface (124) associated with the force detecting region (122) is located on an outer surface (222, 224, 226) of the coupling arm (22).

5. A coupling unit according to embodiment 4, wherein, in a working position (A) of the coupling arm (22), the outer surface (222) runs approximately transverse to a vertical longitudinal centre plane (16) of the coupling arm (22).

6. A coupling unit in accordance with any of the preceding embodiments, wherein, in a working position (A) of the coupling arm (22), the outer surface (224, 226) runs approximately in a direction parallel to a vertical longitudinal centre plane (16) of the coupling arm (22).

7. A coupling unit in accordance with any of the preceding embodiments, wherein the effective surface (124) associated with the force detecting region (122) is located in a free space (96, 94, 98) thereof that is formed by the coupling arm (22).

8. A coupling unit in accordance with any of the preceding embodiments, wherein the coupling arm (22) comprises a carrying structure (60) which is connected by a first end region (24) to the carrier unit (42) and which carries a coupling element (32) at a second end region (26), wherein the carrying structure (60) comprises a bracing structure (62) which connects the first end region (24) to the second end region (26) and supports the second end region (26) relative to the first end region (24) which, in the working position (A) of the coupling arm (22), extends in particular on both sides of a geometrical central planar surface (80) which itself extends in parallel with a central axis (58) of the coupling element (32) and which comprises longitudinal struts (64, 66) that each run from one end region (24) to the other end region (26) and between which there extends at least one connecting element (82, 84, 86, 88, 212) that runs transversely relative to the longitudinal struts (64, 66) and wherein at least one free space (92, 94, 96, 98, 112, 114, 116) extending transversely relative to the geometrical central planar surface (80) lies between the longitudinal struts (64, 66).

9. A coupling unit according to embodiment 8, wherein the force detecting region (122) and the effective surface (124) are arranged on one of the longitudinal struts (64, 66).

10. A coupling unit according to embodiments 8 or 9, wherein the force detecting region (122) and the effective surface (124) are arranged on a connecting element (82, 84, 86, 88, 212).

11. A coupling unit in accordance with any of the embodiments 8 to 10, wherein the effective surface (124) is arranged on an outer surface of the carrying structure (60).

12. A coupling unit in accordance with any of the embodiments 8 to 11, wherein the effective surface (124) is arranged on a side of the carrying structure (60) which faces the free space (96, 94, 98).

13. A coupling unit in accordance with any of the embodiments 8 to 11, wherein the force detecting region (122) and the effective surface (124) are arranged at the first end region (24).

14. A coupling unit in accordance with any of the embodiments 8 to 12, wherein the force detecting region (122) and the effective surface (124) are arranged between the first and second end regions (24, 26).

15. A coupling unit in accordance with any of the preceding embodiments, wherein the at least one force detecting region (122) is arranged on the carrier unit (40).

16. A coupling unit according to embodiment 15, wherein at least one detecting region (122) is provided on a cross-beam (44) of the carrier unit (40).

17. A coupling unit in accordance with any of the preceding embodiments, wherein a plurality of force detecting regions (122) are provided on one or more loaded sections or are distributed over a plurality of loaded sections.

18. A coupling unit according to embodiment 17, wherein the loads are detected in different force detecting regions (122) by means of the magneto-elastic effect with an emphasis on differing directions of detection.

19. A coupling unit in accordance with any of the preceding embodiments, wherein each sensor (132) comprises magnetic poles (142, 144, 146) having header surfaces (162, 164, 166) which face the effective surface (124).

20. A coupling unit according to embodiment 19, wherein the header surfaces (162, 164, 166) are arranged at a spacing from the effective surface (124).

21. A coupling unit according to embodiment 20, wherein a gap (172, 174, 176) of non-magnetic material is provided between the effective surface (124) and the respective header surfaces (162, 164, 166).

22. A coupling unit according to embodiment 21, wherein the gap (172, 174, 176) is formed by a layer of non-magnetic material (178).

23. A coupling unit according to embodiment 22, wherein the gap (172, 174, 176) is formed by a layer of plastics material (178).

24. A coupling unit in accordance with any of the preceding embodiments, wherein the sensor (132) is fixed relative to the respective effective surface (124) by means of a holding device (136) that acts on the sensor (132).

25. A coupling unit according to embodiment 24, wherein the holding device (136) subjects the sensor (132) to a force in the direction of the effective surface (124).

26. A coupling unit in accordance with any of the preceding embodiments, wherein the detection layer (126) is formed by ferro-magnetic material.

27. A coupling unit according to embodiment 26, wherein the detection layer (126) comprises chromium steel.

28. A coupling unit in accordance with any of the preceding embodiments, wherein the detection layer (126) is formed by the material of the force detecting region (122) itself.

Further features and advantages of the invention form the subject matter of the following description and the pictorial illustration of some exemplary embodiments.

### BRIEF DESCRIPTION OF THE DRAWINGS

FIG. 1 shows a rearward view of a motor vehicle with a coupling unit in accordance with the invention;

FIG. 2 an enlarged illustration of a coupling unit in accordance with the invention with a carrier unit and a bearing unit as well as a coupling arm;

FIG. 3 a perspective illustration of a first exemplary embodiment of a coupling arm in accordance with the invention with a bracing structure serving as a carrying structure;

FIG. 4 a sectional view developed along the line 4-4 in FIG. 3;

FIG. 5 a vertical section along the line 5-5 in FIG. 4;

FIG. 6 an enlarged extract from the illustration of the sectional view in accordance with FIG. 4;

FIG. 7 an enlarged extract from the illustration of the sectional view in accordance with FIG. 5;

FIG. 8 an enlarged illustration of an arrangement of a sensor in accordance with the invention on an effective surface of a force detecting region;

FIG. 9 a sectional view similar to FIG. 7 of a second exemplary embodiment of a coupling arm in accordance with the invention;

FIG. 10 a sectional view similar to FIG. 9 of a third exemplary embodiment of a coupling arm in accordance with the invention;

FIG. 11 a sectional view similar to FIG. 6 through a fourth exemplary embodiment of a coupling arm in accordance with the invention;

FIG. 12 a perspective illustration of a coupling arm in accordance with one of the first four exemplary embodiments, provided with coverings;

FIG. 13 a perspective illustration of a fifth exemplary embodiment of a coupling arm in accordance with the invention illustrating the force detecting regions and the corresponding effective surfaces;

FIG. 14 a sectional view along the line 16-16 in FIG. 13;

FIG. 15 a perspective illustration similar to FIG. 13 of a sixth exemplary embodiment of a coupling arm in accordance with the invention and

FIG. 16 a perspective illustration of a seventh exemplary embodiment of a coupling unit in accordance with the invention.

### DETAILED DESCRIPTION OF THE INVENTION

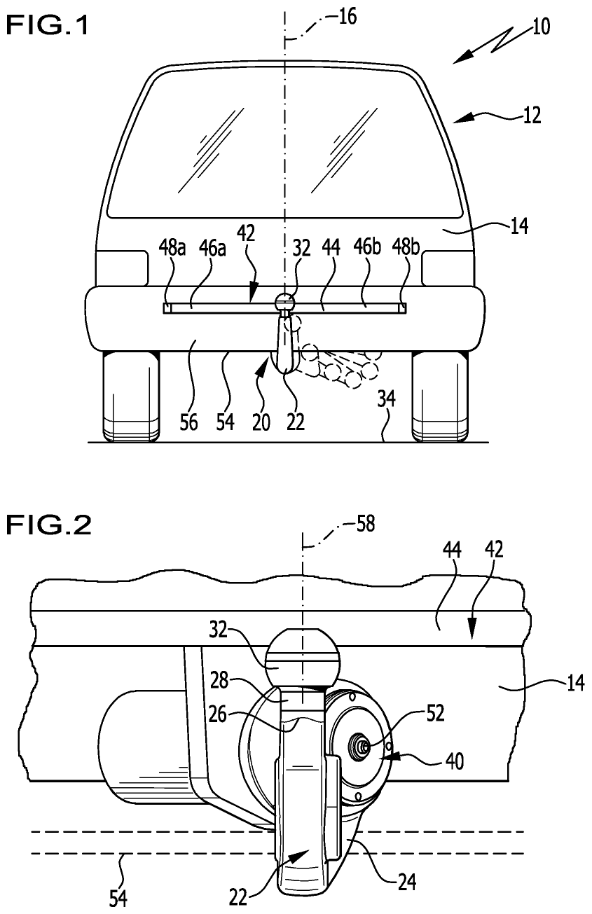

A motor vehicle which is illustrated in FIG. 1 and is designated as a whole by 10 comprises a body 12 that carries in a rear region 14 thereof a coupling unit 20 such as a trailer coupling for example which, as is illustrated in FIGS. 1 and 2, comprises a coupling arm 22 such as a ball neck for example that extends from a first end region 24 that faces the vehicle to a second end region 26 that is remote from the vehicle, wherein a coupling element 32 such as a ball fixing 28 for example upon which there is seated a coupling ball 32 is arranged at the second end region 26, which said coupling is thus connected via the ball fixing 28 to the second end region 26 of the coupling arm 22.

The first end region 24 of the ball neck 22 is connected via a bearing unit that is designated as a whole by 40 to a vehicle-end carrier unit 42 via which a connection to the rear region 14 of the body 12 is effected.

For example, the carrier unit 42 comprises a cross-beam 44 which extends transversely relative to a longitudinal centre plane 16 of the body 12 that is oriented vertically with respect to a horizontal road surface 34 and the coupling unit 20 and is connected to the rear region 14 in the region of its carrier ends 46a, 46b, for example, by means of side carriers 48a, 48b running on both sides of the longitudinal centre plane 16 and parallel thereto which are connected on the one hand to the carrier ends 46a, 46b and on the other hand to the body 12, in particular, to the rear region 14 thereof.

For example, in the simplest case, the bearing unit 40 is constructed in such a way that it establishes a rigid connection between the first end region 24 of the ball neck 22 and the carrier unit 42.

In the exemplary embodiment illustrated in FIGS. 1 and 2, the bearing unit 40 enables the coupling arm 22 to swing about a pivotal axis 52 that is arranged such as to be fixed relative to the vehicle but is nevertheless inclined relative to the vertical longitudinal centre plane 16, in particular, at an acute angle thereto so that, as is illustrated in FIG. 1, the coupling arm 22 is movable therethrough, under a lower edge 54 of a rear end bumper unit 56 of the body 12 and is positionable in a gap between the bumper unit 56 and the rear region 14 of the body 12 in a rest position, whereas, in the working position illustrated in FIG. 1, the coupling arm 22 extends substantially in parallel with the vertical longitudinal centre plane 16, at least however, it runs in such a way that, in the working position, a vertical central axis 58 of the coupling ball 32 represents at the same time a central axis of the ball lug 28 and this central axis 58 lies in the longitudinal centre plane 16 of the body 12.

Bearing units 40 of this type together with the appertaining locking devices are described in detail for example in the European patent applications EP 1 142 732 A, EP 1 741 572 A, EP 1 886 847 A, EP 2 141 034 A, EP 2 261 066 A, EP 2 567 837 A and reference is made to the full extent of the contents of these patent applications.

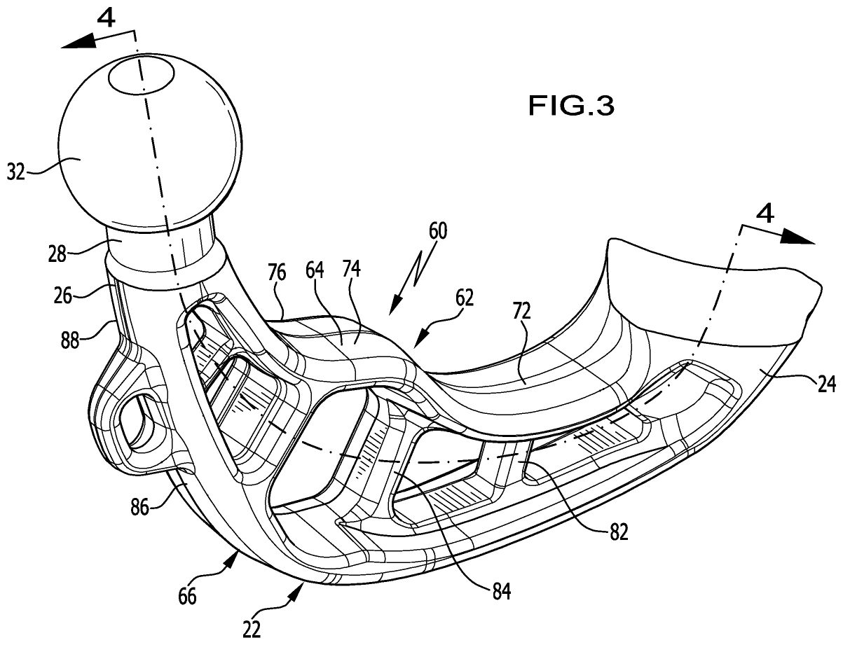

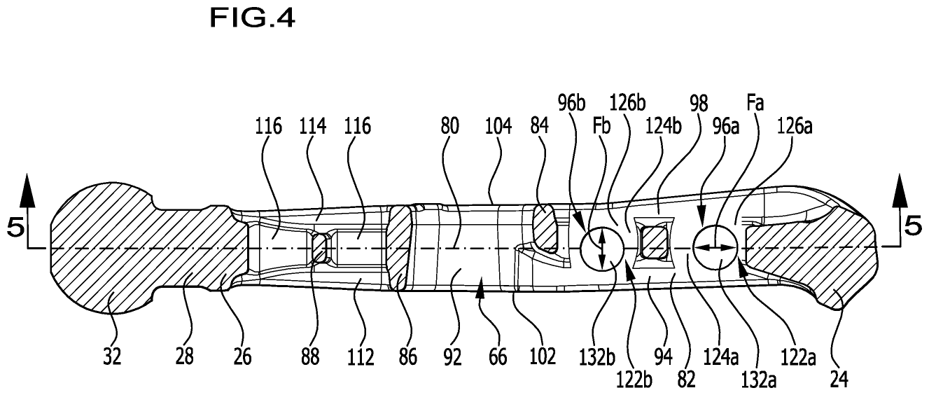

As is illustrated in FIG. 3 and FIG. 4, the coupling arm 22 comprises a carrying structure 60 which runs from the first end region 24 to the second end region 26 and connects the first end region 24 to the second end region 26 in a substantially bending-resistant and torsionally rigid manner, wherein a substantially bending-resistant and torsionally rigid connection is to be understood as a connection which exhibits the following rigidity values when the coupling arm 22 is in the working position and subject to the loads illustrated hereinafter.

The rigidity of the carrying structure can for example be determined when under a load of 100 KN, in the respective spatial direction, the coupling ball 32 moves relative to the first end region maximally 5 mm.

In the exemplary embodiment of the coupling unit 22 illustrated in FIGS. 3 and 4, the carrying structure 60 is in the form of a bracing structure 62 which, taken with respect to the working position of the coupling unit 22, comprises a first longitudinal strut 64 and a second longitudinal strut 66, wherein the first longitudinal strut is arranged on a side remote from the road 34 in the working position and the second longitudinal strut faces the road 34.

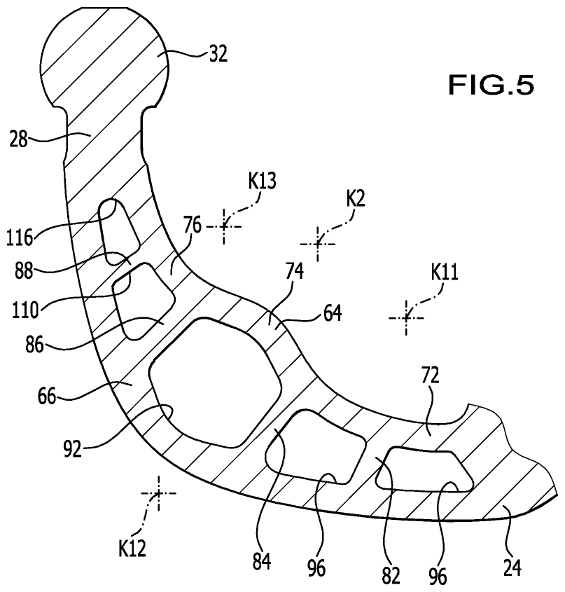

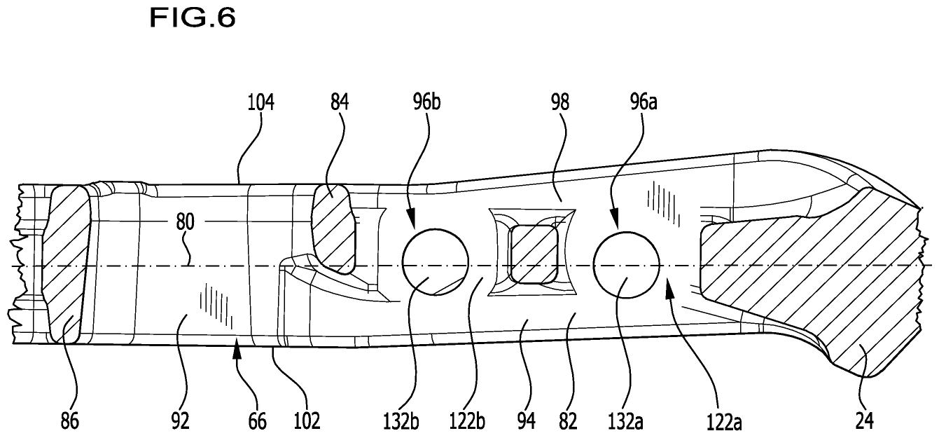

In connection therewith, the first longitudinal strut 64 runs from the first end region 24 which, in particular, is of solid construction, to the second end region 26 which, in particular, is of solid construction, and the second longitudinal strut 66 likewise runs from the first end region 24 to the second end region 26, although it is spaced from the first longitudinal strut 64, wherein, in the working position of the coupling unit 22 for example, the second longitudinal strut 66 is curved whereby a centre of curvature K2 or, if need be, a plurality of centres of curvature are remote from the road 34 (FIG. 5).

In the case of this exemplary embodiment which is illustrated in FIG. 3, the first longitudinal strut 64 also extends from the first end region 24 over a first partial region 72 comprising in all three successive partial regions 72, 74, 76 up to the second end region 26, wherein the partial regions 72 and 76 each exhibit curvatures whose centres of curvature K11 and K13 lie on a side thereof remote from the road 34, whereas the partial region 74 exhibits a curvature whose centre of curvature K12 or centres of curvature lie on a side of the partial region 74 facing the road 34 (FIG. 5).

Furthermore, as is illustrated in connection with the second longitudinal strut 66 in FIG. 4 in particular, both longitudinal struts 64, 66 run in a central planar surface 80 and extend transversely relative to the central planar surface 80 on both sides thereof in every region so that, in particular, both longitudinal struts 64, 66 exhibit in a direction transverse to the central planar surface 80 a width extent of at least 15 mm, still better of at least 20 mm.

Furthermore, the longitudinal struts 64, 66 in the central planar surface 80 exhibit a height extent running transverse to the prolongation direction thereof, of in particular at least 5 mm.

In the case of the first exemplary embodiment illustrated in FIGS. 1 to 4, the longitudinal struts 64 and 66 run without touching each other within the region between the first end region 24 and the second end region 26 but nevertheless they are connected to one another by the connecting struts 82, 84, 86, 88 illustrated in FIG. 3, wherein the connecting struts 82, 84, 86, 88 likewise extend transverse to the central planar surface 80 and rigidly connect the respective longitudinal struts 64 and 66 to one another as is illustrated in FIG. 4 for example.

The connecting struts 82, 84, 86, 88 are preferably all arranged in such a way that the central planar surface 80 intersects them and moreover they run such as to be spaced from one another in the direction from the first end region 24 to the second end region 26.

Due to the bracing structure 62 of the carrying structure 60 for example, there results a plurality of free spaces that are arranged, in particular, between the longitudinal struts 64 and 66.

Thus for example, a first free space 92 is formed in such a way that it passes through the entire bracing structure 62 commencing from a lateral outer contour 102 of the ball neck to the oppositely located lateral outer contour 104 and thus represents a passage in the bracing structure 62.

A further free space 94 is, for example, in the form of a pocket which is setback relative to the lateral outer contour 102 of the ball neck 22 and transitions into two free spaces 96 that are each in the form of through passages which in turn merge into a free space 98 in the form of a pocket that is setback relative to the lateral outer contour 104 of the ball neck.

Preferably, the free space 92 in the form of a through passage is located between the connecting struts 84 and 86 and the free space 96 in the form of a through passage lies between the first end region 24 and the connecting strut 82 as well as the connecting strut 82 and the connecting strut 84 and moreover the free spaces 94 and 98 in the form of pockets lie between the first end region 24 and the connecting strut 84.

Furthermore, free spaces 112 and 114 in the form of mutually oppositely located pockets are also provided between the connecting strut 86 and the second end region 26, wherein the free space 112 is setback relative to the lateral outer contour 102 of the ball neck 22 and the free space 114 is setback relative to the lateral outer contour 104 and free spaces 116 again in the form of through passages are located between these free spaces 112 and 114, wherein the free space 116 in the form of a through passage lies between the connecting strut 86 and the connecting strut 88 and the other free space 116 in the form of a through passage lies between the connecting strut 88 and the second end region 26.

The bracing structure 62 in accordance with the invention incorporating the free spaces 92 to 98 as well as 112 to 116 has the advantage that the mass of the ball neck 22 can thereby be significantly reduced with respect to solid ball necks of the same rigidity, even if they comprise a through hole.

For example, for the purpose of detecting the loads on the coupling arm 22, provision is made for force detecting regions 122a and 122b in the region of the free spaces 96a, 96b in the form of through passages, in particular, on an inner face of the second longitudinal strut 66 facing the free spaces 96 and, associated therewith, are sensors 132a and 132b which detect the forces effective in the detecting regions 122a and 122b due to the loading of the ball neck 22 by means of the magneto-elastic effect.

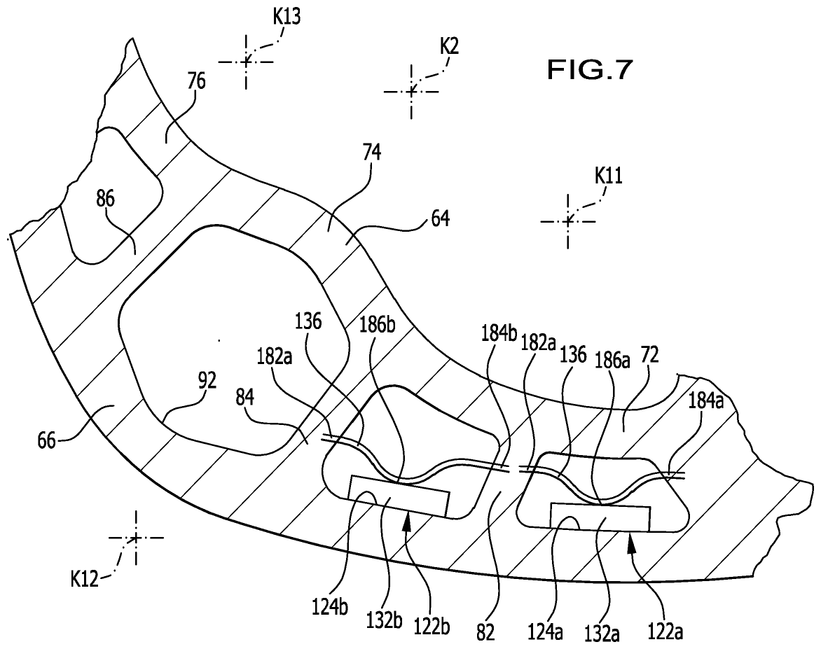

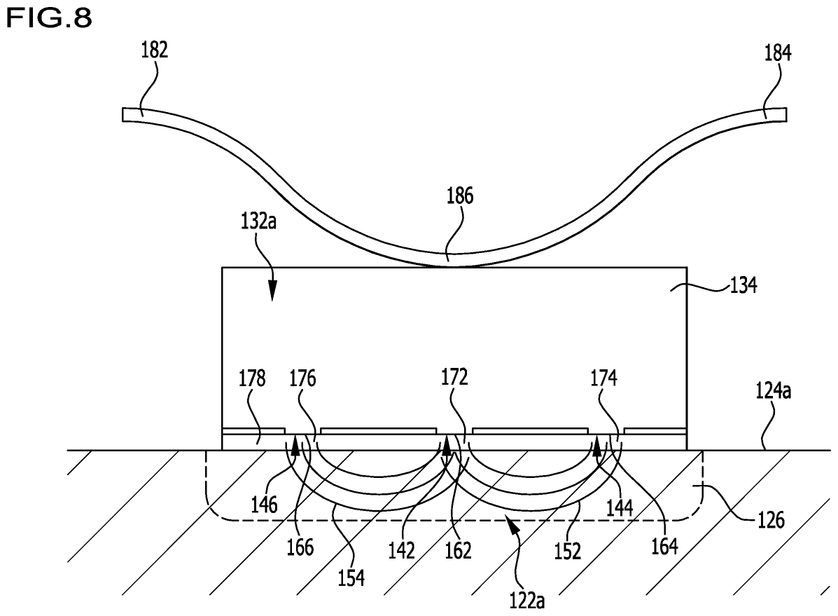

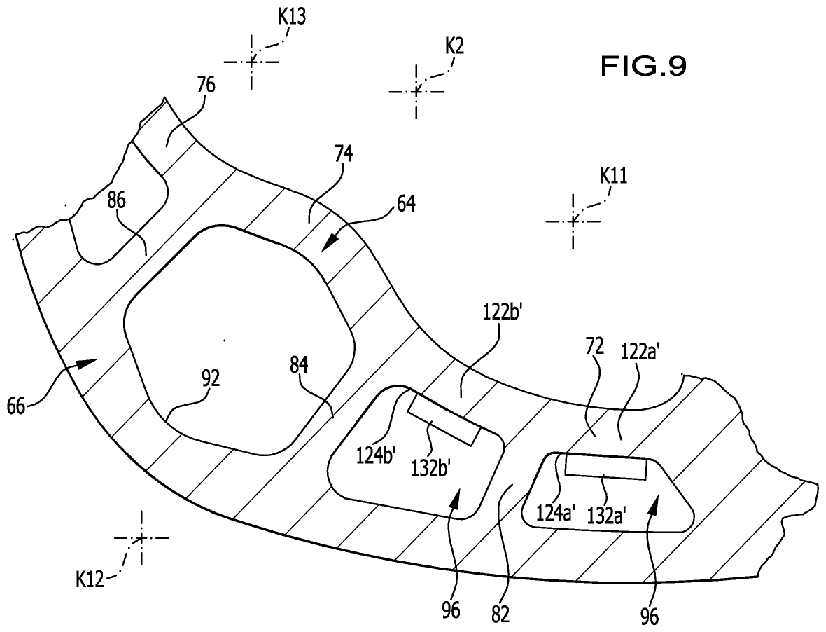

For this purpose, the sensors 132a and 132b are arranged over effective surfaces 124a and 124b of the force detecting regions 122a, 122b which lie on the sides of the longitudinal strut 66 facing the free spaces 96a, 96b in the interior of the bracing structure 62 (FIG. 7), wherein each of the sensors 132a, 132b comprises a plurality of magnetic poles 142, 144 and 146 (FIG. 8) for example by means of which there is produced a coupling of the respective magnetic fields 100 that run between the magnetic poles, for example, the magnetic field 152 between the magnetic poles 142 and 144 and the magnetic field 154 between the magnetic pole 142 and 146, into the respective force detecting region, in the case illustrated in FIG. 8, into the force detecting region 122 of the second longitudinal strut 66 wherein the magnetic permeability of the material in the force detecting region that is affected by the mechanical forces is detected by means of the magnetic fields 152 and 154.

In particular however, the magnetic fields 152 and 154 penetrate into a detection layer 126 of the effective region 122 only by a small amount into the force detecting region.

The sensor 132 is thus in the position of being able to detect the tensile and/or thrust forces that are effective in the detection layer 126 by means of the magneto-elastic effect due to the magnetic fields 152 and 154.

Examples of such sensors 132 are described in DE 10 2016 122 172 A1, DE 30 31 997 A and EP 0 136 086 to which reference is hereby made.

Preferably thereby, header surfaces 162, 164, 166 of the magnetic poles 142, 144, 146 are arranged at a spacing from the effective surface 124 so that a gap 172, 174, 176 of non magnetic material occurs between the effective surface 124 and the respective header surfaces 162, 164, 166, wherein the gap 172, 174, 176 can be an air gap but is preferably a layer of plastics material 178 located between the header surfaces 162, 164, 166 and the effective surface 124 in order to maintain a long-term defined positioning of the header surfaces 162, 164 and 166 relative to the effective surface 124.

Preferably thereby, the entire sensor 132 and in particular a sensor housing 134 of the sensor is subjected to force in the direction of the effective surface 124 so that the layer of synthetic material 178 is clamped between the header surfaces 162, 164 and 166 as well as the effective surface 124.

The application of force to the sensor 132 is effected for example by a respective resilient spring element 136 in the form of a bow spring for example the ends of which are anchored in the coupling arm 22 laterally of the effective surface 124 and which act on the side remote from the effective surface 124 by virtue of a crest 186 of the bow pressing against the sensor housing 134 in order to subject it to a force in the direction of the effective surface 124a.

In order to achieve optimal variations of the magnetic permeability in the detection layer 126, each force detecting region 122 and thus in particular the entire carrying bracing structure 62 is preferably formed from a ferro-magnetic material, preferably chromium steel.

In the case of the first exemplary embodiment illustrated in FIGS. 1 to 8 for example, there are provided two sensors 132, namely, the sensors 132a and 132b which are arranged in such a way that, preferentially, they preferably detect in different spatial directions.

For example, provision is made for the sensor 132a to preferably detect tensile or thrust forces Fa which run parallel to the central planar surface 80 whilst the sensor 132b preferably detects tensile or thrust forces Fb which are directed transversely with respect to the central planar surface 80.

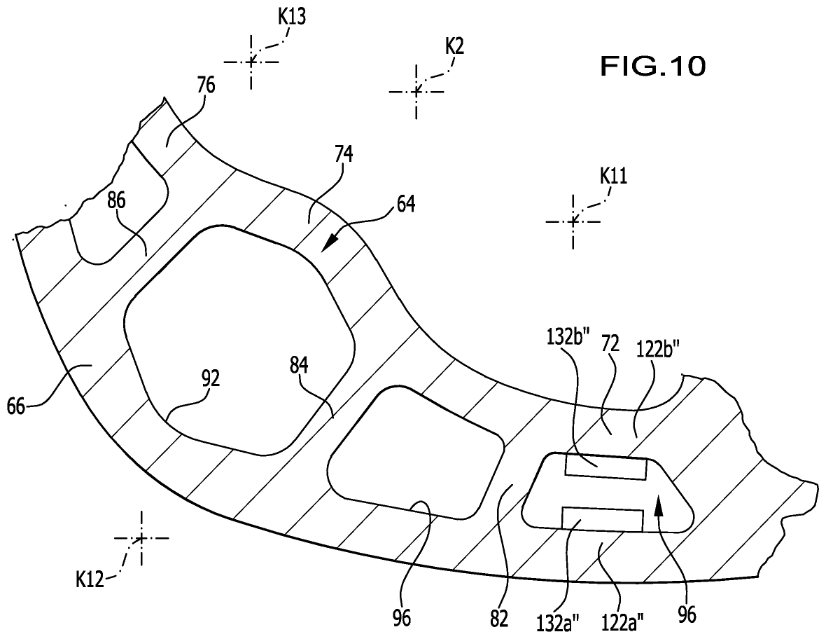

In contrast to the first exemplary embodiment, provision is made in a second exemplary embodiment that is illustrated in FIG. 9 for the force detecting regions 122a′ and 122b′ in the first longitudinal strut 66 to be detected with sensors 132a′ and 132b′, wherein for example the sensors 132a′ and 132b′ are likewise arranged in the free spaces 96.

In all other respects the functioning of the sensors and the detection of the forces by means of the magneto-elastic effect are the same in the second exemplary embodiment as they were in the first exemplary embodiment so that in regard to the detailed description of their functioning and the detailed description of the arrangement of the sensors relative to the force affected region 122 reference may be made to the entire content of the description given in connection with the first exemplary embodiment.

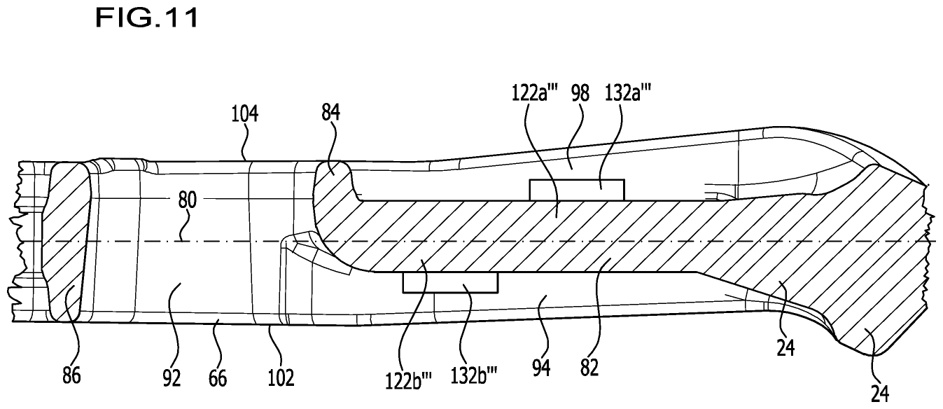

In the case of a third exemplary embodiment which is illustrated in FIG. 10, the sensor 132a″ is, for example, arranged in a free space 96 located next to the first end region 24 of the ball neck and detects the forces in the force detecting region 122a″ of the second longitudinal strut 66 by means of the magneto-elastic effect whilst the sensor 132b″ is likewise arranged in the same free space 126 close to the first end region 24 and detects the forces in the force detecting region 122b″ by means of the magneto-elastic effect.

In all other respects the functioning of the sensors 132 in the third exemplary embodiment is the same as it was in the preceding exemplary embodiments so that in connection with the detailed description of the functioning and the arrangement of the sensors 132 relative to the respective force detecting region 122 reference may be made to the full content of the explanations given in connection with the preceding exemplary embodiments.

In the case of a fourth exemplary embodiment that is illustrated in FIG. 11, the strut structure is modified to the extent that, between the free spaces 94 and 98, the connecting strut 82 extends from the first end region 24 up to the connecting strut 84 in the form of a wall running parallel to the central planar surface 80 and merges into said strut so that the connecting strut 82 completely separates the free spaces 94 and 98 from each other.

In the case of this exemplary embodiment, the connecting strut 82 also extends between the first and second longitudinal struts 64 and 66 and thus forms a continuous wall therebetween.

In the case of this fourth exemplary embodiment for example, sensors 132a′″ and 132b′″ are provided on oppositely located sides of the connecting strut 82 and these sensors detect by means of the magneto-elastic effect the forces occurring therein in the detection regions 122a′″ and 122b′″ formed by the connecting strut 82.

Hereby, in the case of the fourth exemplary embodiment and in regard to the arrangement of the sensors 132a′″ and 132b′″ relative to the detecting regions and the functioning thereof, reference should likewise be made to the full content of the explanations relating to the preceding exemplary embodiments, in particular, the first exemplary embodiment.

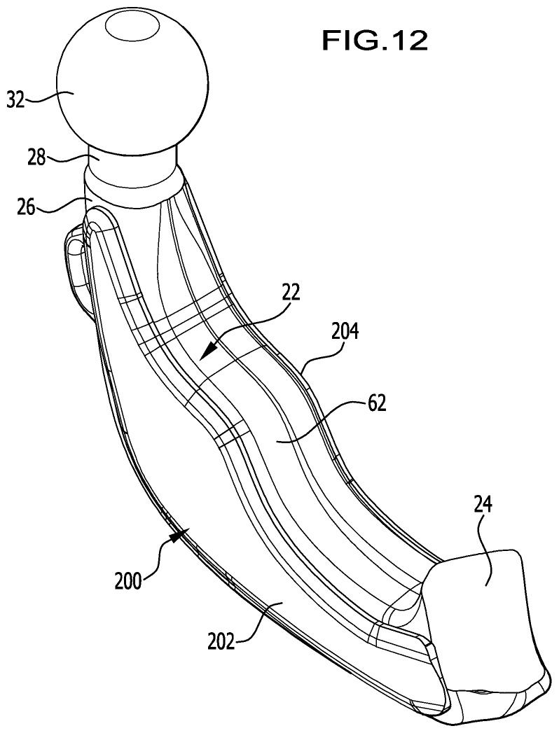

In order to prevent the free spaces 92 to 98 as well as 112 to 116 becoming visible when employing one of the previously described coupling arms 22, provision is made in one exemplary embodiment for a non-load-bearing cladding 200 to be provided for the bracing structure 62 which, as is illustrated in FIG. 12 for example, comprises structurally-rigid coverings 202, 204 which seal the coupling arm 22 in the region of the lateral outer contours 102 and 104 thereof, wherein the coverings 202, 204 for example cover over all of the free spaces 92, 94, 96, 98, 112, 114, 116 that are visible and accessible through the outer contours 102 and 104 and, as is illustrated in FIG. 12, the ball neck 22 that is manufactured in the form of the bracing structure 62 by lending a pleasing outer appearance due to the concealment of the free spaces 92 to 98 as well as 112 to 116 so that the bracing structure 62 is not recognizable as such and the ball neck 22 together with the bracing structure 62 possesses a compact appearance.

The coverings 202, 204 can preferably be manufactured in a simple manner in the form of shaped parts of plastics material, in particular, non-load-bearing shaped parts of plastics material having the desired appropriate optical appearance so that, for example, the possibility thereby exists for the bracing structure 62, particularly in the region of the free spaces 92 to 98 as well as 112 to 116 to be left in the raw state resulting from the manufacturing process, the shaping process for example, and thus unfinished since they are not visible due to the coverings 122 and 124.

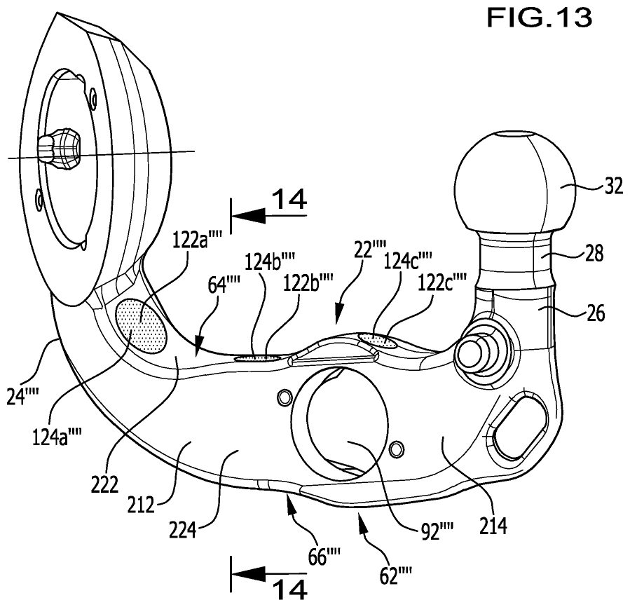

A fifth exemplary embodiment that is illustrated in FIG. 13 comprises a coupling arm 22″″ for example which is formed in a similar manner to the first exemplary embodiment and comprises a bracing structure 62″″ incorporating an upper longitudinal strut 64″″ as well as a lower longitudinal strut 66″″ which however are preferably connected to one another in one piece manner by connecting walls 212 and 214, wherein the connecting wall 212 adjoins the first end region 24″″ and extends up to the free space 92″″ and the connecting wall 214 extends between the free space 92″″ and the second end region 96.

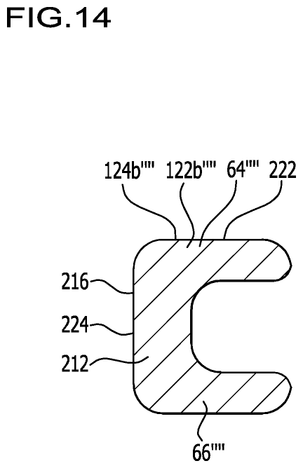

In this case, the coupling arm 22″″ has, as is illustrated in FIG. 14 for example, a C-like cross-sectional shape with the connecting wall 212 and/or the connecting wall 214 serving as a connection between the longitudinal struts 64″″ and 66″″.

In the case of this embodiment of the coupling arm 22″″ for example, provision is made—as is illustrated in FIG. 14—for the forces in the force detecting regions 122a″″, 122b″″ and 122c″″ to be detected by effective surfaces 124a″″, 124b″″ and 124c″″ which are located on outer faces 222 extending transversely relative to the vertical longitudinal central plane 16 and which, in the working position, lie on a side of the first longitudinal strut 64 that is remote from the road 34 so that the sensors can be arranged to face these effective surfaces 124a″″, 124b″″ and 124c″″, wherein the arrangement of the sensors 132 is effected in the same way and the manner of functioning thereof is the same as was described in connection with the preceding exemplary embodiments.

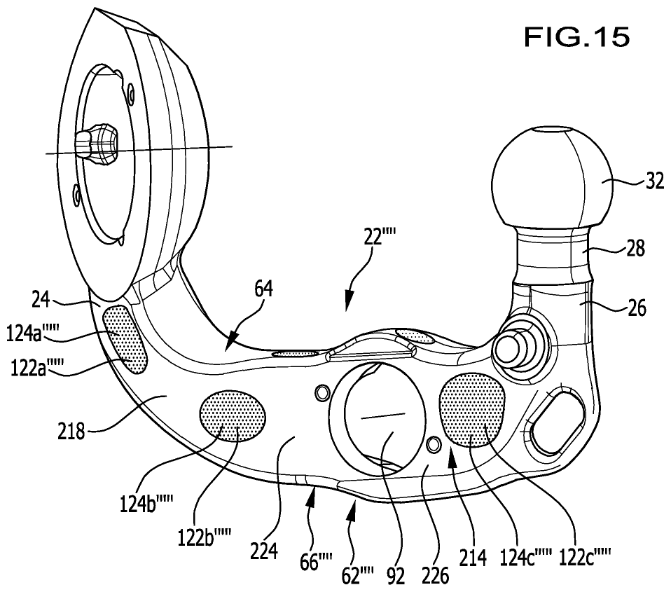

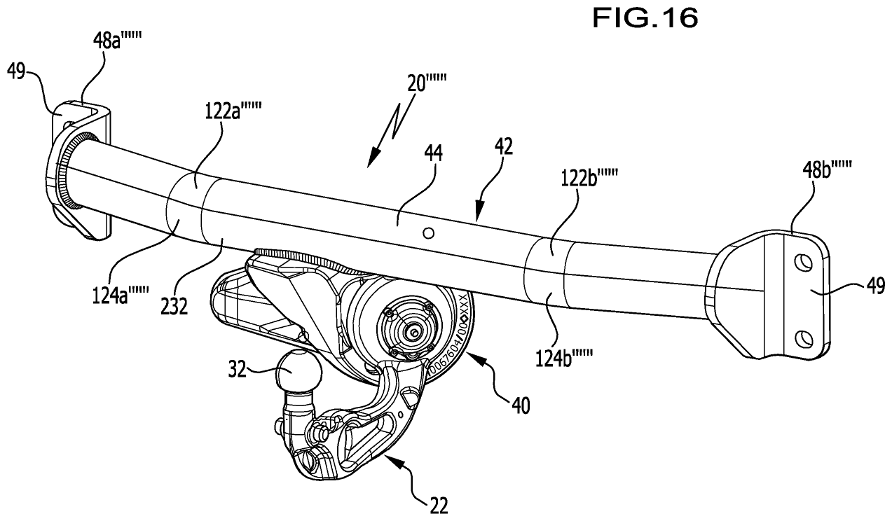

In the case of a sixth exemplary embodiment that is illustrated in FIG. 15 for example, the force detecting regions 122a′″″ and 122b′″″ are arranged in the connecting wall 212 and the detecting region 122c′″″ is arranged in the connecting wall 214, wherein the effective surfaces 124a′″″, 124b′″″ and 124c′″″ appertaining to the force detecting regions 122′″″ are located on the outer faces 224 and 226 of the connecting walls 212 and 214 that extend approximately in parallel with the vertical longitudinal centre plane 16.

In regard to the other features and in particular the arrangement of the sensors 132 relative to the effective surface 124 and the other features of the trailer coupling reference should be made to the full content of the explanations relating to the preceding exemplary embodiments.

In the case of a seventh exemplary embodiment that is illustrated in FIG. 16, the force detecting regions 122a and 122b are not arranged on the ball neck 22, but rather, on the cross-beam 44 of the carrier unit 42 and they detect the forces in the region of the cross-beam that are introduced into the carrier unit 42 by the ball neck 22 via the bearing unit 40, namely, the force detecting regions 122a′′″″ and 122b′′″″ thereof, wherein an outer surface or a peripheral surface 232 of the cross-beam forms the respective effective surfaces 124a′′″″ and 124b′′″″in the force detecting regions 122a′′″″ and 122b′′″″.

By virtue of the sensors 132 assigned to these effective surfaces 124a′′″″ and 124b′′″″, it is possible to detect all of the forces that act on the cross-beam 44 in the most diverse directions and thus too, to detect the forces acting on the ball neck 22 via the coupling ball 32 since the cross-beam 44 transmits these forces to the side carriers 48a′′″″ and 48b′′″″, which in this case do not run parallel to the longitudinal central plane 16, but for example, are mountable with flanges 49 on the rear region 14 of the body 12.

1. Coupling unit that is mountable on the rear end of a vehicle body and comprises a carrier unit which, for its part, is mountable on the vehicle body hidden by a bumper unit and which comprises a coupling arm held by the carrier unit for coupling a trailer or a rear load carrier, at least one force detecting region is provided on sections of the coupling unit that are mechanically loaded by the coupled trailer or the coupled rear load carrier in which a sensor associated with this force detecting region detects the mechanical load acting on this force detecting region by means of the magneto-elastic effect.

2. A coupling unit according to claim 1, wherein the at least one force detecting region comprises an effective surface by means of which the sensor couples a magnetic field into a detection layer of the force detecting region which carries the effective surface and is subjected to the acting mechanical load in order to detect the load that is acting on this detection layer by means of the magneto-elastic effect.

3. A coupling unit in accordance with claim 1, wherein the at least one force detecting region is provided on the coupling arm.

4. A coupling unit according to claim 3, wherein the effective surface that is associated with the force detecting region is located on an outer surface of the coupling arm.

5. A coupling unit according to claim 4, wherein, in a working position of the coupling arm, the outer surface runs approximately transverse to a vertical longitudinal centre plane of the coupling arm.

6. A coupling unit in accordance with claim 1, wherein, in a working position of the coupling arm, the outer surface runs approximately in a direction parallel to a vertical longitudinal centre plane of the coupling arm.

7. A coupling unit in accordance with claim 1, wherein the effective surface associated with the force detecting region is located in a free space thereof that is formed by the coupling arm.

8. A coupling unit in accordance with claim 1, wherein the coupling arm comprises a carrying structure which is connected by a first end region to the carrier unit and carries a coupling element at a second end region, in that the carrying structure comprises a bracing structure which connects the first end region to the second end region and supports the second end region relative to the first end region which, in the working position of the coupling arm, extends in particular on both sides of a geometrical central planar surface which itself extends in parallel with a central axis of the coupling element and which comprises longitudinal struts that each run from one end region to the other end region and between which there extends at least one connecting element that runs transversely relative to the longitudinal struts and in that at least one free space extending transversely relative to the geometrical central planar surface lies between the longitudinal struts.

9. A coupling unit according to claim 8, wherein the force detecting region and the effective surface are arranged on one of the longitudinal struts.

10. A coupling unit according to claim 8, wherein the force detecting region and the effective surface are arranged on a connecting element.

11. A coupling unit in accordance with claim 8, wherein the effective surface is arranged on an outer surface of the carrying structure.

12. A coupling unit in accordance with claim 8, wherein the effective surface is arranged on a side of the carrying structure which faces the free space.

13. A coupling unit in accordance with claim 8, wherein the force detecting region and the effective surface are arranged at the first end region.

14. A coupling unit in accordance with claim 8, wherein the force detecting region and the effective surface are arranged between the first and second end regions.

15. A coupling unit in accordance with claim 1, wherein the at least one force detecting region is arranged on the carrier unit.

16. A coupling unit according to claim 15, wherein at least one detecting region is provided on a cross-beam of the carrier unit.

17. A coupling unit in accordance with claim 1, wherein a plurality of force detecting regions are provided on one or more loaded sections or are distributed over a plurality of loaded sections.

18. A coupling unit according to claim 17, wherein the loads are detected in different force detecting regions by means of the magneto-elastic effect with an emphasis on differing directions of detection.

19. A coupling unit in accordance with claim 1, wherein the respective sensor comprises magnetic poles having header surfaces which face the effective surface.

20. A coupling unit according to claim 19, wherein the header surfaces are arranged at a spacing from the effective surface.

21. A coupling unit according to claim 20, wherein a gap of non-magnetic material is provided between the effective surface and the respective header surfaces.

22. A coupling unit according to claim 21, wherein the gap is formed by a layer of non-magnetic material.

23. A coupling unit according to claim 22, wherein the gap is formed by a layer of plastics material.

24. A coupling unit in accordance with claim 1, wherein the sensor is fixed relative to the respective effective surface by means of a holding device that acts on the sensor.

25. A coupling unit according to claim 24, wherein the holding device subjects the sensor to a force in the direction of the effective surface.

26. A coupling unit in accordance with claim 1, wherein the detection layer is formed by ferro-magnetic material.

27. A coupling unit according to claim 26, wherein the detection layer comprises chromium steel.

28. A coupling unit in accordance with claim 1, wherein the detection layer is formed by the material of the force detecting region itself.
